(19) United States
(12) Patent Application Publication
(10) Pub. No.: US 2017/0033504 A1
(43) Pub. Date: Feb. 2, 2017

(54) CONNECTOR

(71) Applicant: HORIZON CO., LTD., Azumino-shi, Nagano (JP)

(72) Inventors: Kiyotaka IMAI, Matsukawamura, Nagano (JP); Yoichiro HIJIKURO, Chuo-ku, Tokyo (JP)

(21) Appl. No.: 15/120,878

(22) PCT Filed: Jul. 30, 2014
(86) PCT No.: PCT/JP2014/070025

§ 371 Date: Aug. 23, 2016

(30) Foreign Application Priority Data
Apr. 18, 2014 (JP) 2014-002045

(51) Int. Cl. H01R 13/6581; H01R 24/64; H01R 13/6597

(52) U.S. Cl. CPC H01R 13/6581; H01R 13/6597; H01R 24/64; H01R 2107/00

(57) ABSTRACT

A connector comprises: contacts disposed in a row so as to be mutually parallel; a metal case that comprises one surface which is parallel to the direction of disposition of the contacts and two surfaces which are perpendicular with respect to the direction of disposition of the contacts and sandwich the ends of the disposition of the contacts, and that arranged while kept from contact with the contacts; and a synthetic-resin insulator that is formed so as to encase the contacts and the metal case and that exposes part of the contacts and part of the metal case as external contact points.

### TECHNICAL FIELD

The present invention relates to a connector.

### BACKGROUND ART

In order to connect devices such as a smart phone, a tablet PC, an audio player and the like to a USB (Universal Serial Bus) of a personal computer, there is required a connection cable establishing a connection between the smart phone, tablet PC or audio player side and the USB on the personal computer side. A connector disclosed in PTL 1 is an example of a connector on the smart phone, tablet PC or audio player side.

The connector disclosed in PTL 1 uses a U-shaped or cap-shaped metal frame, which allows for discharge with a contact of a drain wire of a board-side connector on the smart phone, tablet PC or audio player as well as grounding with a lock fitting.

### CITATION LIST

### Patent Literature

{PTL 1}: JP 2013-532351 A

### SUMMARY OF INVENTION

### Technical Problem

The connector disclosed in PTL 1 uses a special metal frame that is U-shaped or cap-shaped. This results in the need to manufacture an expensive mold and an increase in production costs.

The present invention has been made against such background, where an object of the present invention is to provide, at low cost, a connector that can be used while inserted into a board-side connector into which the patented connector disclosed in PTL 1 is inserted.

### Solution to Problem

The present invention is a connector including: a plurality of contacts arranged in a line to be parallel with one another; a metal case arranged while kept from contact with the plurality of contacts, and including one surface parallel to a direction in which the plurality of contacts is arranged and two surfaces perpendicular to the direction in which the contacts are arranged also sandwiching both ends of the arrangement of the contacts; and an insulator which is made of synthetic resin, formed so as to contain the plurality of contacts and the metal case, wherein a part of the contacts and a part of the metal case are exposed from the insulator to the outside.

Moreover, according to the connector of the present invention, it is preferred in addition to the aforementioned configuration that the insulator be formed into the shape of a plate including substantially rectangular upper surface and lower surface, and a side surface between the upper surface and the lower surface, and that a part of the contact be exposed on either one of the upper surface and the lower surface while a part of an external contact of the metal case be exposed on the side surface between longer sides of the rectangle. It is also preferred to include an external contact for a contact of a drain wire. It is preferred that the external contacts are arranged so as to sandwich both ends of the arrangement of the contacts on either one of the upper surface and the lower surface.

Furthermore, according to the connector of the present invention, it is preferred that a surface of the insulator on a side having the exposed portion of the contact include a plurality of grooves having a predetermined depth and arranged in a line to be parallel with one another in addition to any of the aforementioned configurations. It is preferred that the each groove is formed in spacing between the contacts adjacent to each other.

### Advantageous Effects of Invention

According to the present invention, there can be provided at low cost the connector that can be used while inserted into the board-side connector into which the connector disclosed in PTL 1 is inserted.

### BRIEF DESCRIPTION OF DRAWINGS

FIG. 1 is a diagram illustrating a manufacturing process of a connector 1 of the present invention, namely a state in which a metal case 11 is to be attached to an insulator 12a including a contact.

FIG. 2 is a diagram illustrating an insulator 12b that covers the insulator 12a and the metal case 11 in FIG. 1 after completing the manufacturing process in FIG. 1.

FIG. 3 FIG. 3 is a diagram illustrating a state in which the whole the manufacturing process is completed, namely a state in which the insulator 12b in FIG. 2 covers the insulator 12a and the metal case 11 after completing the manufacturing process in FIG. 1.

FIG. 4A is a diagram illustrating a cross section taken in a direction orthogonal to a contact exposed surface of the connector 1 when the connector 1 in FIG. 3 and a board-side connector 20 into which the connector 1 is inserted are to be connected together.

FIG. 4B is a diagram illustrating the front of an insertion port 22 of the board-side connector 20.

FIG. 5A is a diagram illustrating a terminal configuration of the board-side connector 20 in FIG. 4A.

FIG. 5B is a diagram illustrating the connector 1 as viewed from a direction indicated with A in the FIG. 4A, and the board-side connector 20 from which a bottom surface of the insertion port 22 is omitted, in other words, the cross section being taken in a connection direction (direction indicated with B in the FIG. 4A) of the board-side connector 20.

FIG. 6 is a pair of diagrams used to explain a method of manufacturing a connector 1A according to another embodiment of the present invention.

FIG. 7 is a pair of diagrams used to explain the method of manufacturing the connector 1A according to another embodiment of the present invention.

### DESCRIPTION OF EMBODIMENTS

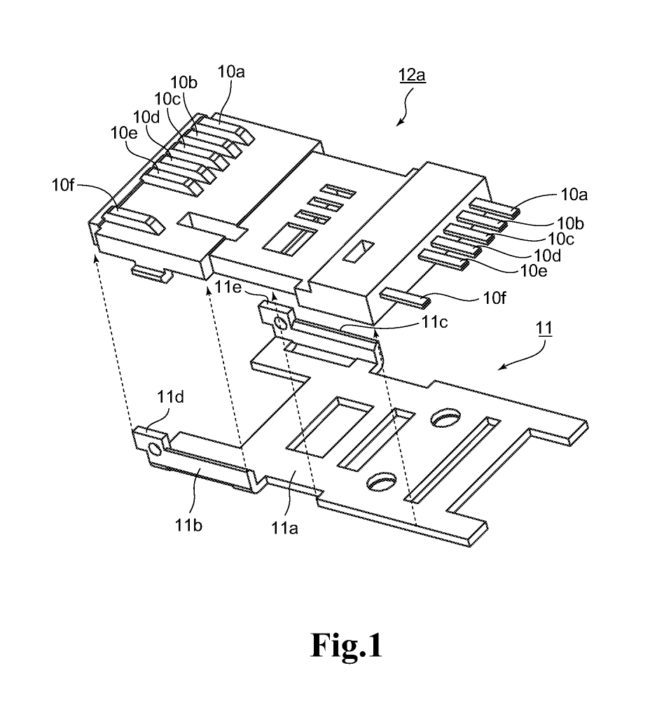

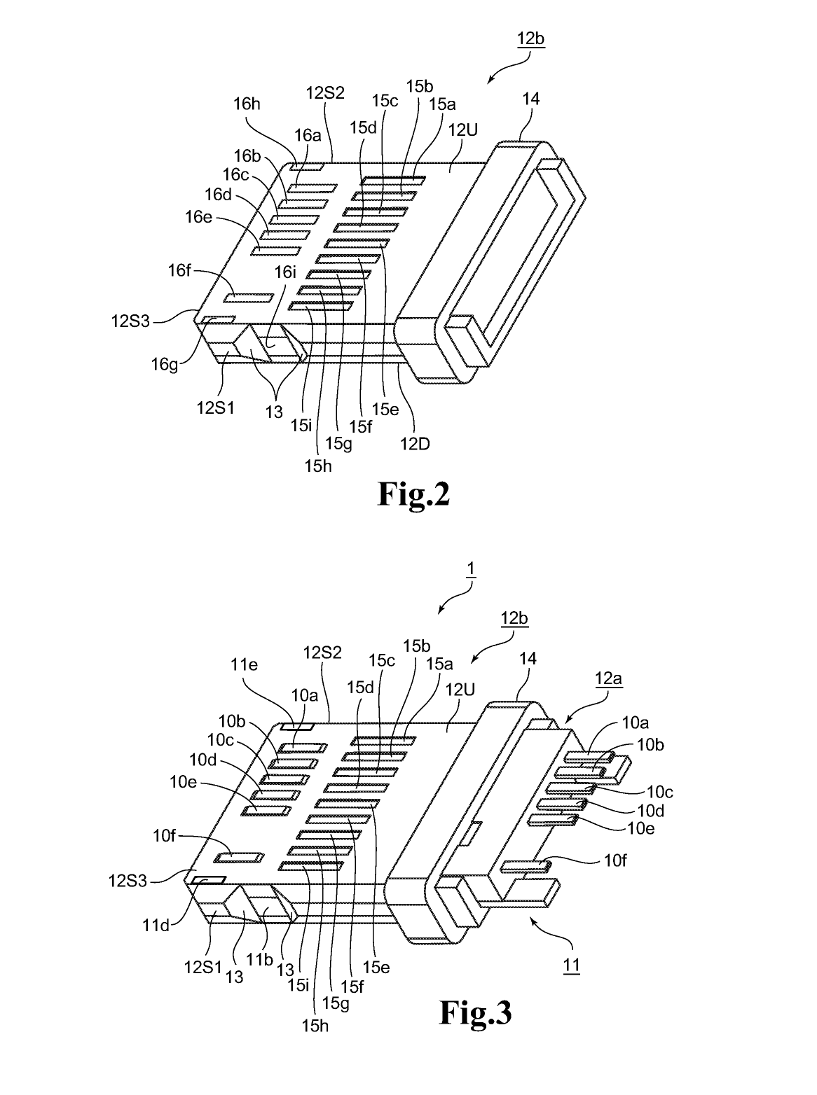

A connector 1 of the present invention includes, as illustrated in FIG. 1, a plurality of contacts 10a, 10b, 10c, 10d, 10e, and 10f arranged in a line to be parallel with one another and a metal case 11 arranged while kept from contact with the contacts 10a to 10f. The metal case 11 including one surface 11a parallel with a direction in which the contacts 10a to 10f are arranged and two surfaces 11b and 11c perpendicular to the direction in which the contacts 10a to 10f are arranged also sandwiching both ends of the arrangement of the contacts 10a to 10f. Moreover, as illustrated in FIGS. 2 and 3, the connector 1 includes insulators 12a and 12b which are made of synthetic resin and formed so as to contain the contacts 10a to 10f and the metal case 11. A part of the contacts 10a to 10f and a part of the metal case 11 are exposed from insulators 12a and 12b as external contacts.

As illustrated in FIG. 2, the insulator 12b is formed into the shape of a plate including substantially rectangular upper surface 12U and lower surface 12D, and side surfaces 12S1, 12S2, and 12S3 between the upper surface 12U and the lower surface 12D.

A part of the insulator 12a and a part of the metal case 11 is exposed from the insulator 12b illustrated in FIG. 2. Specifically, the part of the contacts 10a to 10f are exposed on the upper surface 12U as illustrated in FIG. 3 through holes 16a, 16b, 16c, 16d, 16e, and 16f illustrated in FIG. 2. Moreover, apart of the surface 11b of the metal case 11 is exposed through a hole 16i illustrated in FIG. 2. Note that a part of the surface 11c is also exposed through a hole (not shown) formed on the side surface opposite to the side of the hole 16i. Furthermore, a part of a surface 11d and a part of a surface 11e of the metal case 11 is exposed through holes 16g and 16h in FIG. 2, respectively. Note that while the insulator 12b in FIGS. 2 and 3 includes a protrusion 14, the protrusion 14 may be omitted as it is used to apply force when placing the insulator 12b in a process in which the insulator 12b is placed as illustrated in FIG. 3 on the insulator 12a and the metal case 11 that are in a state illustrated in FIG. 1.

Furthermore, as illustrated in FIGS. 2 and 3, each of grooves 15a, 15b, 15c, 15d, 15e, 15f, 15g, 15h, and 15i having a predetermined depth is formed at a position corresponding to spacing between the adjacent contacts 10a to 10f on the surface of the insulator 12b corresponding to the side including the exposed portions of the contacts 10a to 10f.

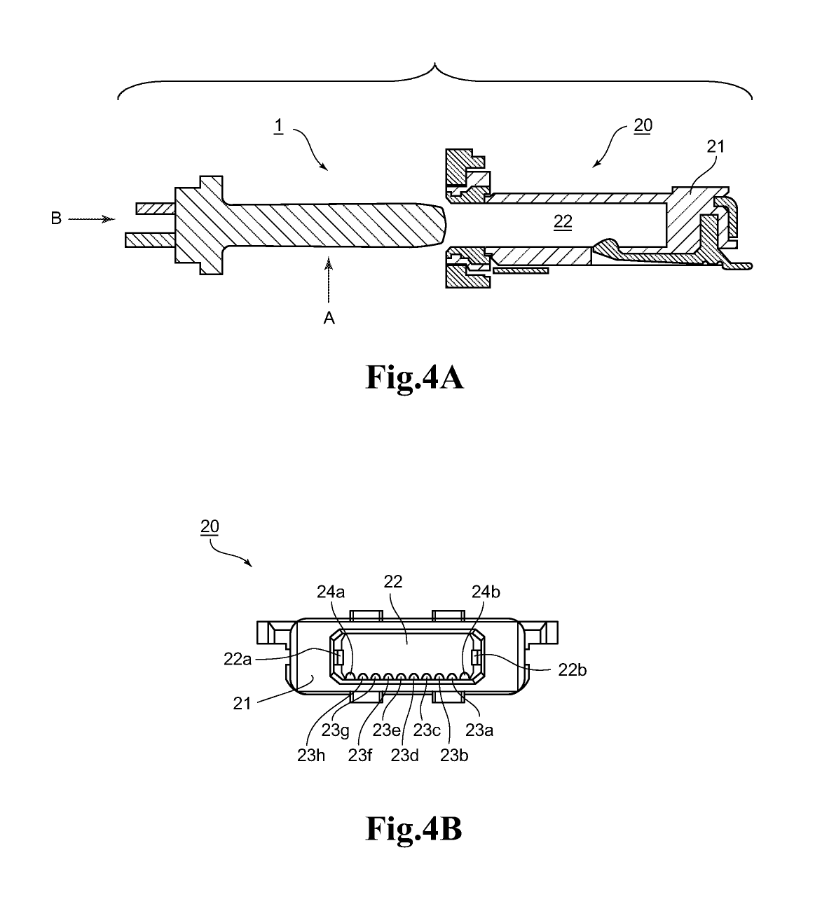

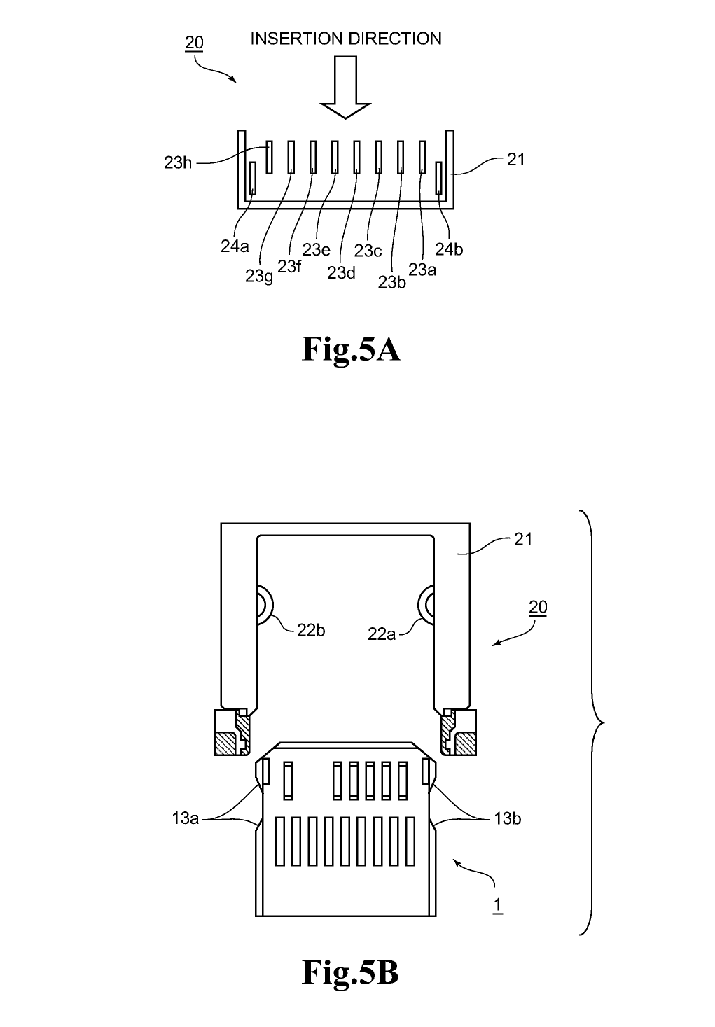

Next, a method of connecting the connector 1 to a board-side connector 20 will be described with reference to FIGS. 4 and 5. FIG. 4A is a diagram illustrating a cross section taken in a direction orthogonal to a contact exposed surface of the connector 1 when the connector 1 in FIG. 3 and the board-side connector 20 into which the connector 1 is inserted are to be connected together. FIG. 4B is a diagram illustrating the front of an insertion port of the board-side connector 20. FIG. 5A is a diagram illustrating a terminal configuration of the board-side connector 20 in FIG. 4A. FIG. 5B is a diagram illustrating the connector 1 as viewed from a direction indicated with A in FIG. 4A, and the board-side connector 20 from which a bottom surface of the insertion port 22 is omitted, in other words, the cross section being taken in a connection direction (direction indicated with B in FIG. 4A) of the board-side connector 20.

As illustrated in FIGS. 4 and 5, the board-side connector 20 includes a connector reception part 21, holding structures 22a and 22b, contacts of a drain wire 24a and 24b and other contacts 23a, 23b, 23c, 23d, 23e, 23f, 23g, and 23h. Note that the contact exposed surface of the connector 1 corresponds to the A direction side in FIG. 4, while the contacts of the drain wire 24a and 24b and the other contacts 23a, 23b, 23c, 23d, 23e, 23f, 23g, and 23h are formed on a bottom surface of the connector reception part 21 of the board-side connector 20.

When the connector 1 is inserted into the insertion port 22 of the connector reception part 21 of the board-side connector 20, notch portions 13a and 13b formed in the insulator 12b are fitted to the holding structures 22a and 22b. A certain amount of force is thus required to remove the connector 1 from the connector reception part 21 of the board-side connector 20. Moreover, the holding structures 22a and 22b, which also serve as ground contacts, of the board-side connector 20 are electrically connected to the surfaces 11b and 11c of the metal case 11 of the connector 1. Furthermore, when the connector 1 is inserted into the insertion port 22 of the connector reception part 21 of the board-side connector 20, the contacts of the drain wire 24a and 24b are electrically connected to a part (an area exposed on the insulator 12b) of each of the surfaces 11d and 11e of the metal case 11.

According to the connector 1, as described above, a metal frame requiring die molding as in PTL 1 is not used so that the connector 1 can be manufactured at low cost. Moreover, the exposure of a metal portion is kept at the minimum required so that corrosion, damage and dirt on the metal portion (that is, the portion serving as the contact and external contact) can be reduced. Furthermore, the grooves 15a to 15i having the predetermined depth are formed at the positions corresponding to the spacings between the adjacent contacts 10a to 10f, so that the grooves 15a to 15i can catch fine dirt and liquid entering while the connector 1 is inserted into the board-side connector 20 to be able to prevent the fine dirt and liquid from reaching the contacts 10a to 10f. Furthermore, the surfaces 11b and 11c can also act as a mechanism of protection for the metal case 11 and the insulator 12a. Furthermore, the surfaces 11d and 11e of the metal case 11 exposed on the surface of the upper surface 12U are configured to function as external contacts for the contact of the drain wire of the board-side connector 20.

### ANOTHER EMBODIMENT

The aforementioned embodiment can be modified in various ways without departing from the gist thereof. While there has been described to realize the state illustrated in FIG. 3 by placing the insulator 12b illustrated in FIG. 2 on the insulator 12a and the metal case 11 illustrated in FIG. 1, the state illustrated in FIG. 3 may be molded integrally, for example. In this case, the protrusion 14 can be omitted as it is used to apply force when placing the insulator 12b in the process in which the insulator 12b is placed as illustrated in FIG. 3 on the insulator 12a and the metal case 11 that are in the state illustrated in FIG. 1.

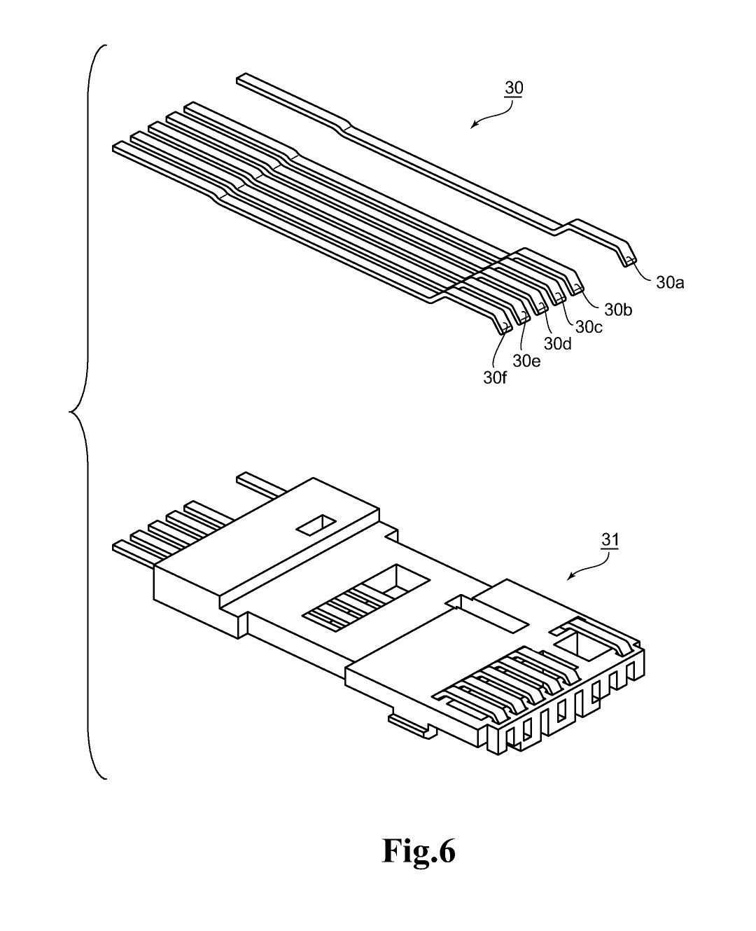

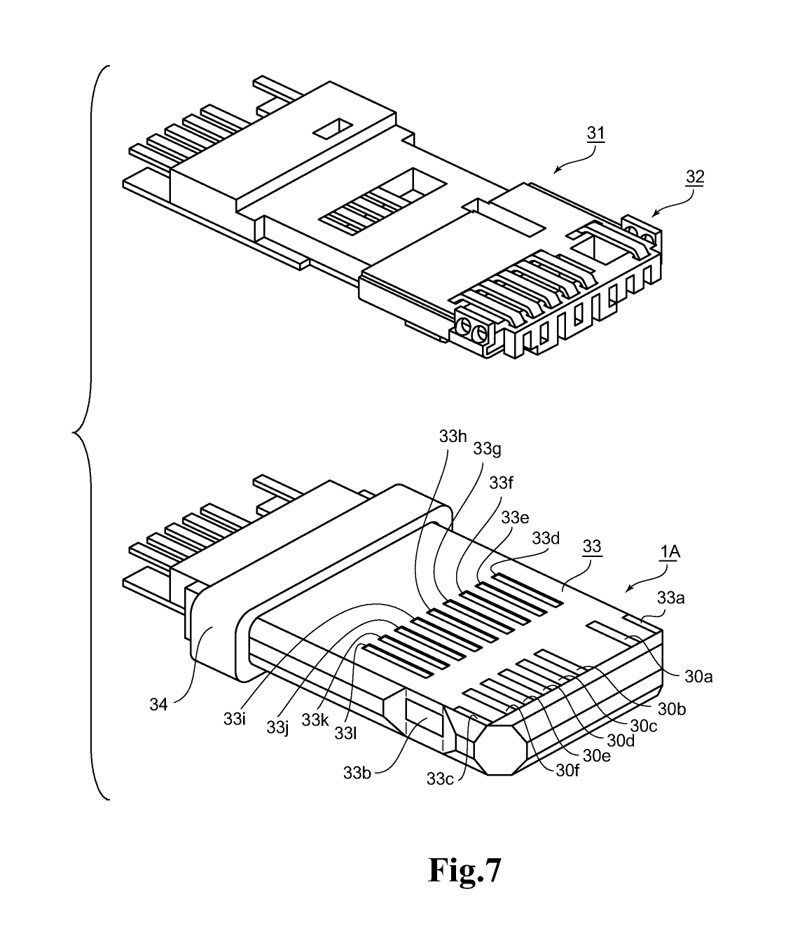

FIGS. 6 and 7 are diagrams used to explain the progress in a manufacturing process of a connector 1A according to another embodiment of the present invention. The connector 1A illustrated in a lower diagram in FIG. 7 is an example of a case where the connector is manufactured by integral molding. For example, an insulator 31 is formed by a special mold integrally with a lead 30 (leads 30a, 30b, 30c, 30d, 30e, and 30f) illustrated in an upper diagram in FIG. 6. Then, as illustrated in an upper diagram in FIG. 7, a metal case 32 is attached to a bottom surface of the insulator 31 that is manufactured by integral molding with the lead 30. Furthermore, as illustrated in a lower diagram in FIG. 7, an insulator 33 is formed by a special mold integrally with the insulator 31 to which the metal case 32 is attached, and fixed by a protrusion 34. Note that grooves 33d, 33e, 33f, 33g, 33h, 33i, 33j, 33k, and 331 are formed on the surface of the insulator 33. Moreover, the insulator 33 is molded such that a part of the aforementioned lead 30 (leads 30a, 30b, 30c, 30d, 30e, and 30f) is exposed on the surface of the insulator 33 as well as that a part of the metal case 32 (33a, 33b, 33c and an area corresponding to an opposite side of 33b, the area not being shown in the figure) is exposed on the surface of the insulator 33. The connector 1A manufactured by adopting such manufacturing method can achieve the effect similar to that achieved by the aforementioned connector 1.

Note that the number and arrangement of the contacts illustrated in FIGS. 1 to 7 above are one example and thus can be modified in various ways. Likewise, the number and arrangement of the grooves 15a to 15i and the grooves 33d to 331 illustrated in FIGS. 2, 3, 6, 7, and the like are one example and thus can be modified in various ways including a form not including a groove.

Moreover, the shape of the metal case 11 and the metal case 32 can be also modified in various ways as long as a part of the metal portion is exposed to function as the external contact for the contact of the drain wire of the board-side connector 20.

### REFERENCE SIGNS LIST

1, 1A connector
10a to 10f contact
30a to 30f lead
11, 32 metal case
12a, 12b, 31, 33 insulator
15a to 15i, 33d to 331 groove

1. A connector comprising:
a plurality of contacts arranged in a line to be parallel with one another;
a metal case arranged while kept from contact with the plurality of contacts, and including one surface parallel to a direction in which the plurality of contacts is arranged and two surfaces perpendicular to the direction in which the contacts are arranged also sandwiching both ends of the arrangement of the contacts; and
an insulator which is made of synthetic resin, formed so as to contain the plurality of contacts and the metal case, wherein a part of the contacts and a part of the metal case are exposed from the insulator to the outside.

2. The connector according to claim 1,
wherein the insulator is formed into the shape of a plate including substantially rectangular upper surface and lower surface, and a side surface between the upper surface and the lower surface,
a part of the contact is exposed on either one of the upper surface and the lower surface, and
a part of the metal case is exposed on the side surface between longer sides of the substantially rectangular surface or exposed on either one of the substantially rectangular upper surface and lower surface so as to function as an external contact for a contact of a drain wire.

3. The connector according to claim 1,
wherein a surface of the insulator on a side having the exposed portion of the contact includes a groove having a predetermined depth at a position corresponding to spacing between the contacts adjacent to each other.
